(19) United States
(12) Patent Application Publication
(10) Pub. No.: US 2006/0165944 A1
(43) Pub. Date: Jul. 27, 2006

(54) Optical recording medium

(75) Inventors: Hironori Kakiuchi, Tokyo (JP); Hiroshi Shingai, Tokyo (JP); Kenji Yamaga, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/332,538

(22) Filed: Jan. 17, 2006

(30) Foreign Application Priority Data
Jan. 21, 2005 (JP) 2005-013860

(51) Int. Cl. B32B 3/02

(52) U.S. Cl. 428/64.4

(57) ABSTRACT

[Object]In order to provide an optical recording medium having an excellent repetitive overwrite property even when the optical recording medium includes a plurality of information layers stacked on a substrate through at least a transparent intermediate layer, and the information layers other than the farthest one from a light incident surface of a laser beam among a plurality of information layers include a recording film formed of a phase transition material having an Sb-based eutectic crystal structure. [Solving Means]

There is provided an optical recording medium comprising a plurality of information layers stacked on a substrate through at least a transparent intermediate layer, wherein the information layers other than the farthest one from a light incident surface of a laser beam among a plurality of information layers include an L1 recording film 34 formed of a phase transition material having an Sb-based eutectic crystal structure, a reflection film 32 disposed at a side of the substrate with respect to the L1 recording film 34, first and second dielectric films 33 and 31 disposed across and adjacent to the reflection film 32 and formed of a material containing a mixed oxide of Zr-based oxide and Cr-based oxide as a major component.

### BACKGROUND OF THE INVENTION

The present invention relates to an optical recording medium, and more particularly, to an optical recording medium comprising a plurality of information layers stacked on a substrate through at least a transparent intermediate layer and having an excellent repetitive overwrite property even when, of a plurality of information layers, the information layers other than the farthest one from a light incident surface of a laser beam include a recording film made of a phase transition material having an Sb-based eutectic crystal structure.

Conventionally, an optical recording medium such as a compact disk (CD) and a digital versatile disk (DVD) has been widely used as a recording medium for writing digital data. As an optical recording medium capable of rewriting the written data, a rewritable optical recording medium such as CD-RW and DVD-RW has been known.

Recently, in order to increase a recording capacity of the optical recording medium as well as to implement a very high data transmission rate, a technique of writing data on the optical recording medium in high density has been proposed. For example, a next generation optical recording medium, in which data is written and reproduced by using a laser beam having a wavelength of about 380 nm through 450 nm and an object lens having a numerical aperture of about 0.85, is being actively developed. Furthermore, a next generation rewritable optical recording medium is being proposed.

Generally, in these rewritable optical recording media, the power of the laser beam irradiated on the information layer including a recording film formed of a phase transition material is modulated to have a plurality of levels corresponding to write power Pw, base power Pb, and erase power Pe to write data on the information layer, and reproduce or erase the data recorded on the information layer. In addition, the data recorded on the information layer can be directly overwritten over a plurality of times by irradiating the laser beam modulated in a plurality of levels on the information layer over a plurality of times.

On the other hand, in order to increase the storage capacity of the optical recording medium, methods of increasing the storage area and the number of the information layers are being developed. Also, a rewritable optical recording medium having a plurality of information layers is being proposed.

However, for a rewritable optical recording medium comprising a plurality of information layers, if the data recorded on the information layers other than the farthest one from the light incident surface of the laser beam is repeatedly directly overwritten, and then, the new recorded data is reproduced, jitter in the reproduced signal becomes degraded as the number of times of the direct-overwrite is increased. Particularly, for a next generation optical recording medium using a high energy laser beam in comparison with a laser beam used in a conventional CD or DVD, jitter of the reproduced signal is significantly increased as the number of times of the direct-overwrite is increased, so that it is impossible to obtain a repetitive overwrite property as desired.

Such a problem that it is jitter of the reproduced signal is significantly increased as the number of times of the direct-overwrite is increased, and it is impossible to obtain a repetitive overwrite property as desired, can be solved by providing dielectric films across and adjacent to the recording medium in each of the information layers other than the farthest one from the light incident surface of the laser beam to protect the recording film.

As an optical recording medium having the information layers other than the farthest one from the light incident surface of the laser beam having such a configuration, form example, there was proposed an optical recording medium comprising a substrate and a plurality of information layers, wherein, among a plurality of information layers, the information layers other than the farthest one from the light incident surface of the laser beam include: a first dielectric film containing Cr, O, and at least one of Zr and Hf; a recording film disposed on the first dielectric film and containing Ge, Te, and at least one of Sb and Bi, its optical properties being reversible by irradiation of a laser beam; and a second dielectric film disposed on the recording film and containing Cr, O, and at least one of Zr and Hf in this order from the incident side of the laser beam, and wherein an atomic percentage of Cr in the first dielectric film is larger than 6 atom %, an atomic percentage of the second dielectric film is at least 9 atom %, and an atomic percentage of Cr in the second dielectric film is larger than that in the first dielectric film (see JP-A-2003-346382).

As disclosed in JP-A-2003-346382, conventionally, a phase transition material a chalcogenide compound, having a chemical composition including the 16^{th} group (i.e., O, S, Se, Te and Po) in a periodic table, is widely used as a phase transition material for forming the recording film included in the information layer of the rewritable optical recording medium. However, recently, a phase transition material having an Sb-based eutectic crystal structure has been proposed, and an optical recording medium including an information layer having a recording film formed of such a phase transition material is being put into practical use (see JP-A-2003-341240).

However, if the recording film included in the information layers other than the farthest one from the light incident surface of the laser beam is formed of such a phase transition material, as disclosed in JP-A-2003-346382, it is impossible to improve a repetitive overwrite property even when a dielectric film formed of a material containing Cr, O, and at least one of Zr and Hf is disposed, respectively, across and adjacent to the recording film in the information layers other than the farthest one from the light incident surface of the laser beam.

### SUMMARY OF THE INVENTION

Therefore, an object of the present invention is to provide an optical recording medium comprising a plurality of information layers stacked on a substrate through at least a transparent intermediate layer and having an excellent overwrite property even when the information layers other than the farthest one from the light incident surface of the laser beam among a plurality of information layers include a recording film formed of a phase transition material having an Sb-based eutectic crystal structure.

As a result of researches for obtaining the object of the present invention, the inventors have found that, in an optical recording medium comprising a plurality of information layers staked through at least a transparent intermediate layer, wherein the information layers other than the farthest one from the light incident surface of the laser beam among a plurality of information layers include a recording medium formed of a phase transition material having an Sb-based eutectic crystal structure, it is possible to prevent degradation of jitter in the reproduced signal and to improve a repetitive overwrite property even when the data recorded on the information layers other than the farthest one from the light incident surface of the laser beam is repeatedly directly overwritten by new data, not by forming the dielectric film containing Cr, O, and at least one of Zr and Hr across the recording film and adjacent to the recording medium in each information layer, but by forming the dielectric film made of a material containing a mixed oxide of Zr-based oxide and Cr-based oxide as a major component across and adjacent to the reflection films included in each information layer.

The present invention has been made based on such recognition. According to the present invention, the object of the present invention is achieved by an optical recording medium comprising a plurality of information layers stacked on a substrate through at least a transparent intermediate layer, wherein at least one of the information layers other than the farthest one from a light incident surface of a laser beam includes: a recording film formed of a phase transition material having an Sb-based eutectic crystal structure; a reflection film provided at a side of the substrate with respect to the recording film; at least a first dielectric film interposed between the recording film and the reflection film and adjacent to the reflection film; and at least a second dielectric film disposed adjacent to the reflection film at a side of the substrate with respect to the reflection film, and wherein the first dielectric film and the second dielectric film are formed of a material containing a mixed oxide Zr-based oxide and Cr-based oxide as a major component.

In the present invention, the reason that the repetitive overwrite property is improved when the first and second dielectric films are formed of a material containing a mixed oxide of Zr-based oxide and Cr-based oxide as a major component, is not clear. However, it has been considered that, since a phase transition material having an Sb-based eutectic crystal structure has a large volume difference between a crystalline state and an amorphous state in comparison with a phase transition material having a chemical composition containing the 16-th element group in a periodic table, a thin reflection film may be deteriorated and deformed due to the repetitive volume change in the phase transition material and its repetitive overwrite property may be degraded, if the state of such a phase transition material is repeatedly changed by irradiating a laser beam on the recording film formed of a phase transition material having an Sb-based eutectic crystal structure. However, if the first and second dielectric films are disposed across and adjacent to the reflection film and formed of a material containing a mixed oxide as a major component, it is possible to prevent deformation or deterioration of the reflection film and sufficiently preserve the functions of the reflection film even when the state of the phase transition material is repeatedly changed, so that it is possible to prevent degradation of jitter generated in the reproduced signal when the direct-overwrite is performed.

According to a preferred embodiment of the present invention, the second dielectric film is disposed adjacent to the reflection film and comprises a first film formed of a material containing a mixed oxide of Zr-based oxide and Cr-based oxide as a major component and a second film disposed at a side of the second film with respect to the first film. According to the preferred embodiment of the present invention, it is possible to implement an excellent recording property as well as further improve a repetitive overwrite property.

According to the present invention, a phase transition material of an Sb-based eutectic crystalline structure is not particularly limited, but a phase transition material of an Sb-based eutectic structure containing Sb and at least an element having a eutectic crystal structure with Sb as a major component, is preferably used.

Herein, the element having an eutectic crystal structure with Sb is not particularly limited if it can obtain an eutectic crystal structure with Sb, but elements such as Ge, Mg, Ga, As, Pb, Bi, Cr, Mn, Ni, Zn, Pd, Ag, and In are preferably used.

Among such phase transition materials of an Sb-based eutectic structure, a phase transition material containing Sb of 79 atom % through 95 atom % and Ge of 5 atom % through 21 atom %, and a phase transition material containing Sb of 70 atom % through 95 atom %, Ge of 0 atom % through 30 atom %, and Mg of 0 atom % through 25 atom %, are preferable. If the recording film is formed of such a phase transition material, it is possible to directly overwrite new data as desired even after the data written on the information layer including such a recording film is preserved in a high temperature for a long time. Therefore, it is possible to improve a storage property.

According to the present invention, the phase transition material having an Sb-based eutectic crystal structure may contain elements other than Sb and the element having a eutectic crystal structure with Sb.

According to the present invention, a material containing a mixed oxide of Zr-based oxide and Cr-based oxide as a major component is not particularly limited, but it may contain other oxide or nitride, for example, third oxide such as MgO, CaO, Sc₂O₃, Y₂O₃, and CeO₂, that can form (partially) stabilized zirconium oxide in addition to the mixed oxide of Zr-based oxide and Cr-based oxide. If such a material contains the third oxide, the content of the third oxide is preferably within a range between 2 mol % and 15 mol % for a total of 100 mol % of Zr-based oxide and the third oxide.

In the present invention, if a material contains a mixed oxide as a major component, this means that the content of the mixed oxide is largest among compounds such as oxide and nitride included in the material.

In the present invention, a material for a mixed oxide of Zr-based oxide and Cr-based oxide is not particularly limited, but is preferably a mixed oxide of ZrO₂ and Cr₂O₃. If the mixed oxide of ZrO₂ and Cr₂O₃ is used, it is possible to further improve a repetitive overwrite property.

A content of Zr-based oxide in the mixed oxide is not particularly limited, but it is preferably within a range between 60 mol % and 100 mol % for a total of 100 mol % of Zr-based oxide and Cr-based oxide, and more particularly, within a range between 70 mol % and 95 mol %. If the content of the Zr-based oxide in the mixed oxide is below 60 mol %, the transmittance of the mixed oxide may be degraded. On the contrary, if the content of the Zr-based oxide in the mixed oxide is 100 mol %, reliability may be degraded due to large internal stress of the Zr-based oxide.

[Advantages]

According to the present invention, it is possible to provide an optical recording medium comprising a plurality of information layers stacked on a substrate through at least a transparent intermediate layer, wherein the optical recording medium has an excellent repetitive overwrite property even when the information layers other than the farthest one from a light incident surface of a laser beam among a plurality of information layers include a recording film formed of a phase transition material having an Sb-based eutectic crystal structure.

### BRIEF DESCRIPTION OF THE DRAWINGS

FIG. 1 is a partially cutaway schematic perspective view illustrating an optical recording medium according to a preferred embodiment of the present invention.

FIG. 2 is a schematic enlarged cross-sectional view along a ling A of FIG. 1.

FIG. 3 is a schematic enlarged cross-sectional view illustrating an L0 information layer.

FIG. 4 is a schematic enlarged cross-sectional view illustrating an L1 information layer.

FIG. 5 is a schematic enlarged cross-sectional view illustrating an L1 information layer of an optical recording medium according to another embodiment of the present invention.

FIG. 6 is a graph showing a repetitive overwrite property of optical recording medium samples #1 through #3.

FIG. 7 is a graph showing repetitive overwrite properties of optical recording medium comparison samples #1 through #5.

FIG. 8 is a graph showing a repetitive overwrite property of optical recording medium samples #6 through #10.

### DETAILED DESCRIPTION OF THE PREFERRED EMBODIMENTS

Hereinafter, preferred embodiments of the present invention will now be described with reference to the accompanying drawings.

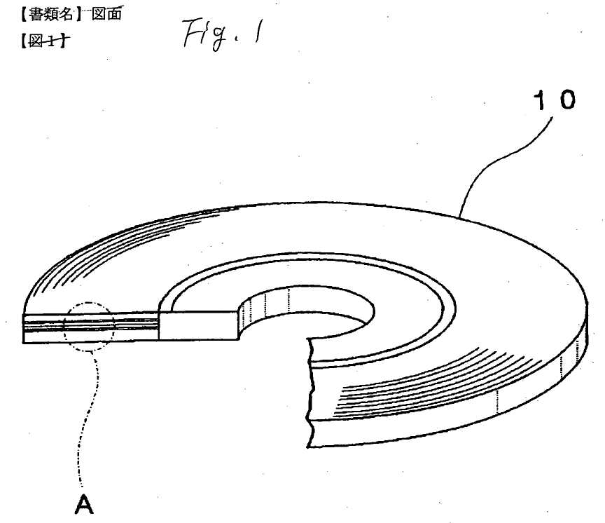

FIG. 1 is a partially cutaway schematic perspective view illustrating an optical recording medium according to a preferred embodiment of the present invention.

As shown in FIG. 1, the optical recording medium 10 according the present embodiment has a disk shape having an outer diameter of 120 mm and a thickness of 1.2 mm.

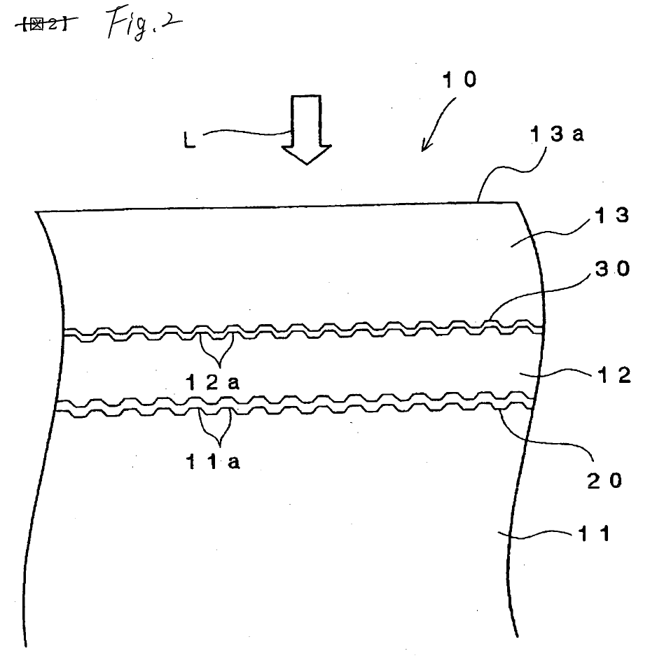

The optical recording medium 10 according to the present embodiment is a rewritable optical recording medium, as shown in FIG. 2, comprising a substrate 11, a transparent intermediate layer 12, an light transmission layer 13, an L0 information layer 20 interposed between the substrate 11 and the transparent intermediate layer 12, an L1 information layer 30 interposed between the transparent intermediate layer and the light transmission layer 13, and a light incident surface 13a on a surface

According to the present invention, the L0 information layer constitutes an information layer far from the light incident surface 13a, and the L1 information layer 30 constitutes an information layer near the light incident surface 13a.

In FIG. 2, the optical recording medium 10 according to the present embodiment is configured in such a way that a laser beam L having a wavelength λ of 380 nm through 450 nm is irradiated to the light transmission layer 13 through an object lens having a numerical aperture NA of 0.85 in a direction along an arrow L.

The substrate 11 functions as a support for obtaining a mechanical strength required for the optical recording medium 10.

A material for forming the substrate 11 is not particularly limited if it can function as a support of the optical recording medium 10, but a resin is preferably used. Such a resin may be preferably made of a polycarbonate resin, or a polyolefin resin due to its manufacturability. According to the present embodiment, the substrate 11 is made of a polycarbonate resin.

According to the present embodiment, the substrate 11 has a thickness of 1.1 mm.

According to the present embodiment, since the laser beam L is irradiated through the light transmission layer 13 disposed opposite to the substrate 11, the substrate is not required to have a light transmittance.

As shown in FIG. 2, the substrate 11 has a groove 11a on its surface. The groove 11a functions as a guide track of the laser beam L when data is written to the L0 information layer 20 and reproduced from the L0 information layer 20.

The substrate 11 having a groove 11a on its surface is manufactured by an injection molding method using a stamper (not shown).

The transparent intermediate layer 12 has a function of physically and optically separating the L0 information layer 20 and the L1 information layer 30 with a sufficient interval.

As shown in FIG. 2, a groove 12a is formed on the surface of the transparent intermediate layer 12. The groove 12a formed on the surface of the transparent intermediate layer 12 functions as a guide track of the laser beam L when data is written to and reproduced from the L1 information layer 30.

The transparent intermediate layer 12 is required to have a sufficiently high light transmittance in order to allow the laser beam L to pass through it when data is written to and reproduced from the L0 information layer 20. Therefore, a material for forming the transparent intermediate layer 12 is required to have little optical absorption or reflection within a wavelength region from a fore infrared ray to an ultraviolet ray and have a small birefringence. The material form forming the transparent intermediate layer 12 is not particularly limited if it satisfies the aforementioned requirement, but the transparent intermediate layer 12 is preferably made of an ultraviolet (UV) curable resin composition including a UV curable resin such as a UV curable acrylic resin.

The transparent intermediate layer 12 is preferably formed in such a way that a UV curable resin composition solution is coated by a spin coating method to form a coating, a stamper (not shown) having a stamp pattern similar to that used to manufacture the substrate 11 is covered on the surface of the coating, and ultraviolet rays are irradiated via the stamper.

The light transmission layer 13 is a layer for transmitting the laser beam L, and comprises a light incident surface 13a on its surface.

A material for forming the light transmission layer 13 is required to have little optical absorption within a wavelength region from a fore infrared ray to a UV ray and have a small birefringence. The material for forming the light transmission layer 13 is not particularly limited if it satisfies the aforementioned requirement, but a resin composition containing a UV curable resin or an electron beam curable resin is preferably used to form the light transmission layer 13. Particularly, a resin composition containing the UV curable acrylic resin is preferably used.

The light transmission layer 13 is preferably formed to have a thickness of 30 μm through 200 μm.

The light transmission layer 13 is preferably formed by coating a resin composition solution on the L1 information layer 30 by a spin coating method, but it may be formed by bonding a resin sheet made of a light transmitting resin to the surface of the L1 information layer 30 by using an adhesive.

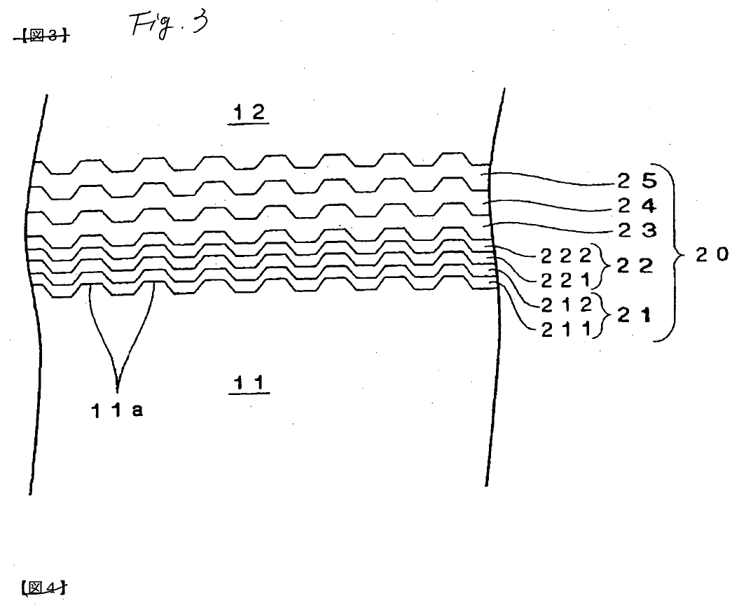

FIG. 3 is a schematic enlarged cross-sectional view illustrating an L0 information layer 20.

As shown in FIG. 3, according to the present embodiment, the L0 information layer 20 is configured by stacking a reflection film 21, a second dielectric film 22, an L0 recording film 23, a first dielectric layer 24, and a heat-sink film 25 from the side of the substrate 11.

The reflection film 21 has a function of reflecting the laser beam L irradiated to the L0 recording film 23 via the light transmission layer 13 and the L1 information layer 30 to feed it back to the light transmission layer 13, and at the same time, effectively discharging the heat generated in the Lo recording film 23 by the irradiation of the laser beam L.

A material for forming the reflection film 21 is not particularly limited, but includes Mg, Al, Ti, Cr, Fe, Co, Ni, Cu, Zn, Ge, Ag, Pt, Au, Nd, and the like. Of them, a metallic material having a high reflectance, such as Al, Au, Ag, Cu, an alloy of Ag and Cu, and an alloy containing at least one of them is preferably used to form the reflection film 21. Particularly, if the reflection film 21 contains Ag, it would be preferable because it is possible to provide a reflection film 21 having an excellent surface flatness and accordingly reduce a noise level in the reproduced signal.

The reflection film 21 may be formed by a single film or two or more films, but according to the present embodiment, the reflection film 21 is structured by stacking a first film 212 formed of a metallic material including Ag and a second film 211.

The thickness of the reflection film 21 is not particularly limited, but preferably within a range between 10 nm and 300 nm, and more particularly, between 40 nm and 200 nm.

For example, the reflection film 21 is formed by a sputtering method, and the like.

The second dielectric film 22 and the first dielectric film 24 has a function of physically and chemically protecting the L0 recording film 23 as well as discharging the heat generated in the L0 recording film 23, and further increasing change of optical properties before and after the irradiation of the laser beam L.

A material for forming the second dielectric film 22 and the first dielectric film 24 is not particularly limited if it is a transparent dielectric material within a wavelength range from 380 nm to 450 nm corresponding to the wavelength range of the laser beam L, but the second dielectric film 22 and the first dielectric film 24 are preferably formed of oxide, nitride, sulfide, carbide, fluoride, or a compound of them containing at least one metal element selected from a group consisting of Si, Zn, Al, Ta, Ti, Co, Zr, Pb, Ag, Sn, Ca, Ce, V, Cu, Fe, and Mg.

Each of the second dielectric film 22 and the first dielectric film 24 may be configured in a single film or by stacking two or more films, but according to the present embodiment, the second dielectric film 22 is configured by stacking a first film 222 formed of a mixture of ZnS and SiO₂ and a second film 221 formed of oxide of Ce and Al, and the first dielectric film 24 is configured in a single film.

The thicknesses of the second dielectric film 22 and the first dielectric film 24 are not particularly limited, but the thickness of the second dielectric film 22 is preferably within a range between 3 nm and 35 nm, and the thickness of the first dielectric film 24 is preferably within a range between 10 nm and 80 nm.

The second dielectric film 22 and the first dielectric film 24 are formed by using, for example, a sputtering method.

The L0 recording film 23 is a film for recording data by forming a recording mark. It is formed of a phase transition material, and configured in a single film. Since the phase transition material has a different reflectance in a crystalline state and an amorphous state, this fact is used to write and reproduce data.

A phase transition material for forming the L0 recording film 23 is not particularly limited, but it is preferable to include a phase transition material containing at least one element selected from a group consisting of Sb, Te, Ge, Ag, Tb and Mn.

The thickness of the L0 recording film 23 is not particularly limited, but the thickness of the L0 recording film 23 is preferably within a range from 8 nm to 25 nm.

The L0 recording film 23 is formed by, for example, a sputtering method.

The heat-sink film 25 has a function of discharge the heat transmitted from the L0 recording film 23 via the first dielectric film 24.

A material for forming the heat-sink film 25 is not particularly limited if it has a high light transmittance for the laser beam L and it can discharge the heat generated in the recording film 23, but the heat-sink film 25 is preferably formed of a material having higher thermal conductivity than that of the first dielectric film 24, particularly, AlN, Al₂O₃, SiN, ZnS, ZnO, SiO₂, and the like.

The heat-sink film 25 is preferably formed to have a thickness of 10 nm through 120 nm.

The heat-sink film 25 is formed by, for example, a sputtering method.

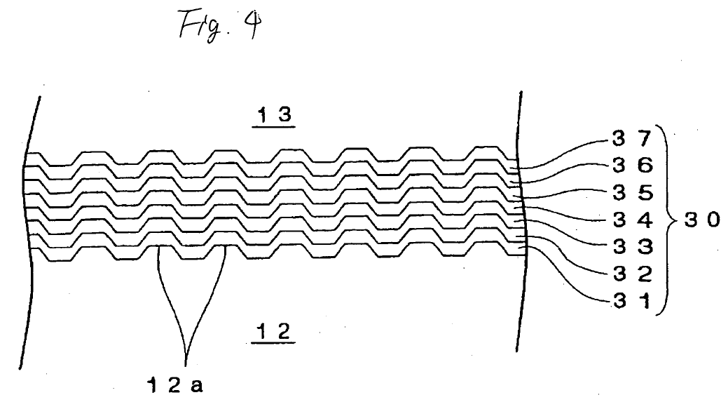

FIG. 4 is a partially enlarged cross-sectional view illustrating an L1 information layer 30.

As shown in FIG. 4, according to the present embodiment, the L1 information layer 30 is configured by stacking a fourth dielectric film 31, a reflection film 32, a third dielectric film 33, an L1 recording film 34, a second dielectric film 35, a first dielectric film 36, and a heat-sink film 37 from the substrate 11.

The fourth dielectric film 31 has functions of sufficiently preserving a function of the reflection film, which will be described in detail below, and discharging the heat generated in the L1 recording film 34 by the laser beam L irradiation in association with the reflection film 32.

A material for forming the fourth dielectric film 31 is not particularly limited if it contains a mixed oxide of Zr-based oxide and Cr-based oxide as a major component, but it may contain other oxide or nitride, for example, third oxide such as MgO, CaO, Sc₂O₃, Y₂O₃, and CeO₂ that can produce stabilized zirconium oxide or partially stabilized zirconium. If such a material contains the third oxide, the content of the third oxide is preferably within a range from 2 mol % to 15 mol % for a total of 100 mol % including the Zr-based oxide and the third oxide.

The mixed oxide of the Zr-based oxide and the Cr-based oxide is not particularly limited, but is preferably a mixed oxide of ZrO₂ and Cr₂O₃. The content of the Zr-based oxide in the mixed oxide is preferably within a range from 60 mol % to 100 mol % for a total of 100 mol % including the Zr-based oxide and the Cr-based oxide, and more preferably, within a range from 70 mol % to 95 mol %. If the content of the Zr-based oxide is below 60 mol % in the mixed oxide, the transmittance of the mixed oxide may be decreased, while, if it is 100 mol %, reliability may be degraded by high internal stress of the Zr-based oxide.

According to the present embodiment, the fourth dielectric film 31 is formed of a material containing a mixed oxide of ZrO₂ and Cr₂O₃ of a molar ratio of 90:10 as a major component. If the fourth dielectric film 31 is formed of such a mixed oxide, it is possible to further improve a repetitive overwrite property.

The fourth dielectric film 31 may be configured in a single film or by stacking two or more films, but according to the present embodiment, it is configured in a single film.

The fourth dielectric film 31 is preferably formed to have a thickness of 2 nm through 50 nm. If the thickness of the fourth dielectric film 31 is smaller than 2 nm, the heat-sink effectiveness may be degraded as well as it is difficult to sufficiently preserve the function of the reflection film 32, which will be described below. On the contrary, if the thickness of the fourth dielectric film 31 is over 50 nm, the internal stress generated during the fourth dielectric film 31 is formed becomes large, the fourth dielectric film 31 becomes susceptible to cracks, and at the same time, the repetitive overwrite property may be degraded.

The fourth dielectric film 31 can be formed on the surface of the transparent intermediate layer 12 by a vapor growth method using a chemical seed containing the elements similar to those of the fourth dielectric film 31. The vapor growth method may include a vacuum deposition method, a sputtering method, and the like, but the fourth dielectric film 31 is preferably formed of a sputtering method.

The reflection film 32 has functions of reflecting the laser beam L irradiated on the L1 recording film 34 via the light transmission film 13 to allow the laser beam to be output back from the light transmission layer 13 as well as effectively discharging the heat generated in the L1 recording film 34.

A material for forming the reflection film 32 is not particularly limited, but includes metallic materials similar to those preferably used to form the reflection film 21 in the L0 information layer 20 shown in FIG. 3. Particularly, if the reflection film 32 contains Ag, it is possible to form a reflection film 32 having an excellent surface flatness and reduce a noise level of a reproduced signal, and thus, it would be preferable.

The reflection film 32 is required to have a thin thickness in order to increase a light transmittance of the L1 information layer 30, and according to the present embodiment, it is possible to improve a repetitive overwrite property even when the reflection film is formed in a thin thickness. Therefore, the reflection film 32 preferably has a thickness of 5 nm through 25 nm, and more preferably, 10 nm through 15 nm.

The reflection film 32 is preferably formed on the surface of the fourth dielectric film 31 by, for example, a sputtering method.

The third dielectric film 33 has functions of sufficiently preserving the aforementioned functions of the reflection film, physically and chemically protecting the L1 recording film 34 in association with the second dielectric film 35, and discharging the heat generated in the L1 recording medium 34 by the laser beam L irradiation toward the reflection film 32.

A material for forming the third dielectric film 33 is not particularly limited, but includes materials similar to those used to form the fourth dielectric film 31. According to the present embodiment, similarly to the fourth dielectric film 31, the third dielectric film 33 is formed of a material containing a mixed oxide of ZrO₂ and Cr₂O₃ having a molar ratio of 90:10. If the third dielectric film 33 is formed of such a mixed oxide, it is possible to further improve a repetitive overwrite property.

The third dielectric film 33 may be configured in a single film or by stacking two or more films, but according to the present embodiment, it is configured in a single film.

The third dielectric film 33 is preferably formed to have a thickness of 2 nm through 15 nm. If the thickness of the third dielectric film 33 is below 2 nm, it may be difficult to form the third dielectric film 33 in a continuously connected film and to sufficiently preserve the functions of the reflection film 32. On the contrary, if the thickness of the third dielectric film 33 is over 15 nm, it may be difficult to effectively release the heat generated in the L1 recording film 34 to the reflection film, and the repetitive overwrite property may be degraded.

The third dielectric film 33 can be formed on the surface of the reflection film 32 by a vapor growth method using a chemical seed containing the elements similar to those of the third dielectric film 33. The vapor growth method may include a vacuum deposition method, a sputtering method, and the like, but the fourth dielectric film 31 is preferably formed by a sputtering method.

The L1 recording film 34 is a film for forming a recording mark to write data. It is formed of a phase transition material, and configured in a single film. Since the phase transition material has a different reflectance in a crystalline state and an amorphous state, this fact is used to write and reproduce data.

A phase transition material having an Sb-based eutectic crystal structure for forming the L1 recording film 34 is not particularly limited, but a phase transition material containing Sb and at least one of elements having a eutectic crystal structure with Sb as a major component is preferably used. Particularly, a phase transition material containing Sb of 79 atom % through 95 atom % and Ge of 5 atom % through 21 atom %, or a phase transition material containing Sb of 70 atom % through 95 atom %, Ge of 0 atom % through 30 atom %, and Mg of 0 atom % through 25 atom % is preferably used. According to the present embodiment, the L1 recording film 34 is formed of a phase transition material containing Sb of 79 atom % through 95 atom % and Ge of 5 atom % through 21 atom %. If the L1 recording film 34 is formed of such a phase transition material, regardless of the thickness of the L1 recording film 34, a storage property of the L1 information layer 30 is further improved.

The L1 recording film 34 is preferably formed to have a thickness of 2 nm through 15 nm, and more particularly, 4 nm through 9 nm. If the L1 recording film is formed to have a thickness of 2 nm through 15 nm, a storage property of the L1 information layer 30 is further improved.

The L1 recording film 34 can be formed by, for example, a vapor growth method using a chemical seed containing the elements similar to those of the L1 recording film 34. The vapor growth method includes a vacuum deposition method, a sputtering method, and the like, but it is preferable to form the L1 recording film 34 by a sputtering method.

The second dielectric film 35 has functions of physically and chemically protecting the L1 recording film 34 in association with the third dielectric film 33 as well as discharging the heat generated in the L1 recording film 34 by the laser beam L irradiation toward the heat-sink film 37 which will be described below. In addition, the second dielectric film 35 functions as a barrier film that prevents the elements contained in the first dielectric film 36 from being diffused to the L1 recording film 34.

A material for forming the second dielectric film 35 is not particularly limited, but the second dielectric film 35 is formed of oxide, nitride, sulfide, carbide, fluoride, or a combination of them containing at least a metallic material selected from a group consisting of Ti, Zr, Hf, Ta, Si, Al, Mg, Y, Ce, and Zn. Of them, the second dielectric film 35 is preferably formed of a material containing ZrO₂ as a major component. If the second dielectric film 35 is formed of such a material, it is possible to quickly discharge the heat generated in the L1 recording film 34.

The second dielectric film 35 is preferably formed to have a thickness of 3 nm through 15 nm. If the thickness of the second dielectric film 35 is below 3 nm, it is difficult to sufficiently obtain the function as a barrier film, and the heat-sink effectiveness is degraded. On the contrary, if the thickness of the second dielectric film 35 is over 15 nm, the internal stress generated during the second dielectric film 35 is formed becomes large, and thus, the second dielectric film 35 becomes susceptible to cracks.

The second dielectric film 35 is formed by, for example, a sputtering method.

The first dielectric film 36 has a function of increasing adherence with the second dielectric film 35 and the heat-sink film 37.

A material for forming the first dielectric film 36 is not particularly limited if it has a high light transmittance for the laser beam L and high adherence with the second dielectric film 35 and the heat-sink film 37, but the first dielectric film 36 is preferably formed of a mixture of ZnS and SiO₂. If the first dielectric film 36 is formed of a mixture of ZnS and SiO₂, a molar ratio between ZnS and SiO₂ is preferably within a range of 60:40 through 95:5. If a molar ratio of the ZnS is lower than 60%, a refractive index of the first dielectric film 36 is decreased. As a result, a difference of reflectance between a portion of the L1 recording film 34 having a recording mark and the other portion of L1 recording film 34 not having a recording mark may be significantly decreased. On the other hand, if a molar ratio of ZnS is higher than 95%, it is difficult to form the first dielectric film 36 as a perfect transparent film, and others shortcomings such as reduction in signal output are generated.

The first dielectric film 36 is preferably formed to have a thickness of 5 nm through 50 nm. If the thickness of the first dielectric film 36 is below 5 nm, the heat-sink film 37 becomes susceptible to cracks. On the contrary, if the thickness of the first dielectric film 36 is over 50 nm, the heat-sink effectiveness may be degraded.

The first dielectric film 36 is formed by, for example, a sputtering method.

The heat-sink film 37 has a function of discharging the heat transmitted from the L1 recording film 34 via the second and first dielectric film 35 and 36.

A material for forming the heat-sink film 37 is not particularly limited if it has a high light transmittance for the laser beam L and it can discharge the heat generated in the L1 recording film 34, but the heat-sink film 37 is preferably formed of a material having thermal conductivity higher than that of the second dielectric film 35, specifically, AlN, Al₂O₃, SiN, ZnS, ZnO, SiO₂ and the like.

The heat-sink film 37 is preferably formed to have a thickness of 20 nm through 70 nm. If the thickness of the heat-sink film 37 is below 20 nm, it may be difficult to obtain sufficient heat-sink effectiveness. On the contrary, if the thickness of the heat-sink film 37 is over 70 nm, the formation of the heat-sink film 37 takes long time. Thus, productivity of an optical recording medium 10 may be degraded.

The heat-sink film 37 is formed by, for example, a sputtering method.

When data is written to the L0 or L1 information layer 20 or 30 of the optical recording medium 10 according to the present embodiment configured as described above, and the data recorded on the L0 or L1 information layer 20 or 30 is directly overwritten, a laser beam of which power is modulated among a write power Pw, an erase power Pe, and a base power Pb is focused on the L0 recording film 23 included in the L0 information layer 20 or the L1 recording film 34 included in the L1 information layer 30 from the light transmission layer 13.

According to the present embodiment, the L1 information layer 30 includes the L1 recording film 34 formed of a phase transition material having an eutectic crystal structure containing Sb of 79 atom % through 95 atom % and Ge of 5 atom % through 21 atom %, the third and fourth dielectric film 33 and 31 are disposed across and adjacent to the reflection film 32 having a thickness of 5 nm through 25 nm, respectively, and formed of a material containing a mixed oxide of ZrO₂ and Cr₂O₃ of a molar ratio of 90:10 as a major component. Studies of the present inventors have found that, in this case, it is possible to improve a storage property as well as a repetitive overwrite property. Therefore, according to the present embodiment, it is possible to write data on the L1 information layer 30 as desired and repeatedly direct-overwrite the data recorded in the L1 information layer 30 as desired.

In addition, according to the present embodiment, as described above, it is possible to improve a storage property and form the L1 recording film 34 with a small thickness as well as improve a repetitive overwrite property and form the reflection film 32 with a small thickness. Therefore, it is possible to form the L1 information layer 30 with a small thickness, and thus, the L1 information layer 30 can have a high light transmittance for the laser beam L having a wavelength of 380 nm through 450 nm, and it is possible to minimize reduction of the light intensity of the laser beam L when the laser beam L passes through the L1 information layer 30. Therefore, according to the present embodiment, it is possible to the laser beam L on the L0 recording film 23 included in the L0 information layer 20 via the L1 information layer 30. In addition, it is possible to write data on the L0 information layer 20 as desired and reproduce or eliminate the data recorded on the L0 information layer 20 as desired.

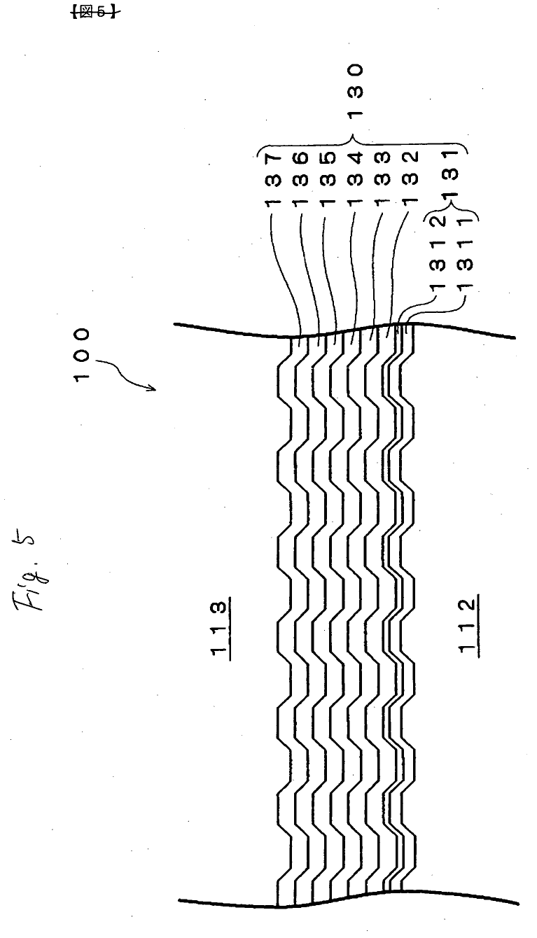

FIG. 5 is a schematic enlarged cross-sectional view illustrating an L1 information layer of an optical recording medium according to a preferred embodiment of the present invention.

Similarly to the optical recording medium 10 shown in FIGS. 1 through 4, the optical recording medium 100 according to the present embodiment is formed in a disk shape and has an outer diameter of about 120 mm and a thickness of about 1.2 mm.

As shown in FIG. 5, the optical recording medium 100 according to the present embodiment has an L1 information layer 130 configured by stacking a fourth dielectric film 131, a reflection film 132, a third dielectric film 133, an L1 recording film 134, a second dielectric film 135, a first dielectric film 136, and a heat-sink film 137 from a transparent intermediate layer 112. The optical recording medium 100 according to the present embodiment has a similar configuration to those of FIGS. 1 through 4 except that the fourth dielectric film 131 of the L1 information layer 130 is composed of a first film 1313 adjacent to the reflection film 132 and formed of a material containing a mixed oxide of Zr-based oxide and Cr-based oxide as a major component and a second film 1311 disposed at a side of the transparent intermediate layer 112 with respect to the first film 1312.

Studies of the present inventors has found that, when fourth dielectric film 131 is composed of the first and second films 1312 and 1311, it is possible to improve optical properties such as transmittance as well as further improve a repetitive overwrite property.

The first film 1312 of the fourth dielectric film 131 has functions and is made of materials similar to those of the fourth dielectric film 31 of the optical recording medium 10 shown in FIGS. 1 through 4. According to the present embodiment, similarly to the fourth dielectric film 31 of the optical recording medium 10 shown in FIGS. 1 through 4, the first film 1312 is formed of a material containing a mixed oxide of ZrO₂ and Cr₂O₃ of a molar ratio of 90:10 as a major component. If the first film 1312 is formed of such a mixed oxide, it is possible to further improve a repetitive overwrite property.

The first film is preferably formed to have a thickness of 2 nm through 15 nm. If the thickness of the first film 1312 is below 2 nm, the heat-sink effectiveness may be degraded, and at the same time, it may be difficult to preserve the functions of the reflection film 32. On the contrary, if the thickness of the first film 1312 is over 15 nm, the internal stress generated during the first film 1312 is formed becomes large, the first film 1312 becomes susceptible to cracks, and at the same time, the repetitive overwrite property may be degraded.

The second film 1311 of the fourth dielectric film 131 has functions of increasing the light transmittance of the L1 information layer 130 and improving optical properties.

A material for forming the second film 1311 is preferably a material having a high light transmittance for the laser beam L, and more preferably, the second film 1311 is formed of a mixed oxide of ZnS and SiO₂. If the second film 1311 is formed of a mixed oxide of ZnS and SiO₂, it is possible to increase the light transmittance of the L1 information layer 130, and at the same time, to improve a repetitive overwrite property. If the second film 1311 is formed of a mixed oxide of ZnS and SiO₂, a molar ratio of ZnS and SiO₂ is preferably within a range of 60:40 through 95:5, similar to that of the first dielectric film 36 of the optical recording medium 10 shown in FIGS. 1 through 4.

The second film 1311 is preferably formed to have a thickness of 5 nm through 50 nm. If the thickness of the second film 1311 is below 5 nm, the heat-sink film 37 becomes susceptible to cracks. On the contrary, if the thickness of the second film 1311 is over 50 nm, the heat-sink effectiveness may be degraded.

According to the present embodiment, the L1 information layer 130 includes the L1 recording film 134 formed of a phase transition material having an eutectic crystal structure containing Sb of 79 atom % through 95 atom % and Ge of 5 atom % through 21 atom %, the third dielectric film 133 disposed across and adjacent to the reflection film 132 having a thickness of 5 nm through 25 nm and formed of a material containing a mixed oxide of ZnS and SiO₂ of a molar ratio of 90:10 as a major component, the fourth dielectric film 131 composed of the first film 1312 and the second film 1311 disposed at a side of the transparent intermediate layer 112 with respect to the first film 1312 and formed of a mixed oxide of ZnS and SiO₂. Studies of the present inventors revealed that it is possible to improve a light transmittance, a storage property, and a repetitive overwrite property in this case. Therefore, according to the present embodiment, it is possible to write data on the L1 information layer 130 as desired, and repeatedly direct-overwrite data on the L1 information layer 130 as desired.

### EXPERIMENTAL EXAMPLE

In order to clarify effects of the present invention, experimental examples will be described.

An optical recording medium sample #1 has been manufactured as described below.

First, through an injection molding, a polycarbonate substrate having a thickness of 1.1 nm and a diameter of 120 mm was manufactured. A groove was formed on the surface of the substrate with a groove pitch of 0.32 μm.

Then, the polycarbonate substrate was set on a sputtering machine, and the L0 information layer was formed on the surface having the groove by a sequential sputtering method, in which a reflection film consisting of a first film having a thickness of 40 nm and containing Ag of 98.4 atom %, Nd of 7 atom %, Cu of 0.9 atom % and N, and a second film having a thickness of 60 nm and containing Ag of 98.4 atom %, Nd of 0.7 atom %, and Cu of 0.9 atom %; a second dielectric film consisting of a first film having a thickness of 10 nm and containing a mixture of CeO₂ and Al₂O₃ of a molar ratio of 80:20 and a second film having a thickness of 10 nm and containing a mixture of ZnS and SiO₂ of a molar ratio of 50:50 as a major component; an L0 recording film having a thickness of 10 nm and containing a phase transition material composed of Sb of 77.1 atom %, Te of 18.7 atom %, and Ge of 4.2 atom % as a major component; the first dielectric film having a thickness of 40 nm and containing a mixture of ZnS and SiO₂ of a molar ratio 80:20 as a major component; and a heat-sink film having a thickness of 30 nm and containing AlN as a major component, are sequentially formed.

In this case, the second film of the reflection film, the first and second films of the second dielectric film, the L0 recording film, and the first dielectric film were formed by a sputtering method using a target having a composition corresponding to each film in an argon gas atmosphere.

On the other hand, the first film of the reflection film and the heat-sink film were formed by a responsive sputtering method in an Ar and N gas atmosphere by using an AgNdCu target or an Al target.

Then, the polycarbonate substrate having the L0 information layer was set on a spin coat machine. A solution of a UV curable acrylic resin composition was coated on the L0 information layer. A transparent stamper having a groove was superposed thereon. The UV curable acrylic resin composition was cured by irradiating ultraviolet rays with the polycarbonate substrate being rotated and with the solution of the UV curable acrylic resin composition being expanded. As a result, the transparent intermediate layer having a thickness of 25 μm was formed. The groove formed on the transparent intermediate layer had a groove pitch of 0.32 μm.

In addition, an initialization process was performed on the L0 recording film by using a semiconductor laser having a wavelength of 810 nm and an output power of 500 mW to crystallize the L0 recording film.

Then, the polycarbonate substrate having the L0 information layer and the transparent intermediate layer was set on a sputtering machine, and the L1 information layer was formed by a sequential sputtering method, in which a fourth dielectric film having a thickness of 20 nm and containing a mixed oxide of ZrO₂ and Cr₂O₃ of a molar ratio of 90:10 as a major component; a reflection film having a thickness of 15 nm and containing an alloy of Ag of 98 atom %, Pd of 1 atom %, and Cu of 1 atom %; a third dielectric film having a thickness of 6 nm and containing a mixed oxide of ZrO₂ and Cr₂O₃ of a molar ratio of 90:10 as a major component; an L1 recording film having a thickness of 6 nm and including a phase transition material containing Sb of 98.0 atom % and Ge of 13.0 atom % as a major component; a second dielectric film having a thickness of 6 nm and containing a mixed oxide of ZrO₂ and Y₂O₃ of a molar ratio of 97:3 as a major component; a first dielectric film having a thickness of 12.5 nm and containing a mixture of ZnS.SiO₂ of a molar ratio of 80:20 as a major component; and a heat-sink film having a thickness of 35 nm and containing AlN as a major component, are sequentially formed on the transparent intermediate layer.

In this case, the heat-sink film was formed by a responsive sputtering method using an Al target in an atmosphere of Ar and N gases.

On the other hand, the first, second, third and fourth dielectric films, the reflection film, and the L1 recording film were formed by a sputtering method using a target having a composition corresponding to each film in an atmosphere of an Ar gas.

Then, a coat film was formed by coating a solution of a UV curable acrylic resin composition on the surface of the reflection film of the L1 information layer through a spin coating method. The solution of a UV curable acrylic resin composition was cured by irradiating ultraviolet rays, so that a light transmission layer having a thickness of 75 μm was formed.

In addition, an initialization process was performed on the L1 recording film by using a semiconductor laser having a wavelength of 810 nm and an output power of 500 mW to crystallize the L1 recording film.

As a result, an optical medium sample #1 has been manufactured.

Then, an optical recording medium sample #2 was manufactured by using a method similar to that of the optical recording medium sample #1, except that the fourth dielectric film consists of a second film having a thickness of 15 nm and containing a mixed oxide of ZnS and SiO₂ of a molar ratio of 80:20 as a major component and a first film having a thickness of 4 nm and containing a mixed oxide of ZrO₂ and Cr₂O₃ of a molar ratio of 90:10 as a major component, instead of the fourth dielectric film of the sample #1, having a thickness of 20 nm and containing a mixed oxide of ZrO₂ and Cr₂O₃ of a molar ratio of 90:10 as a major component.

Then, an optical recording medium sample #3 was manufactured by using a method similar to that of the optical recording medium sample #1, except that the L1 recording film was formed by using a phase transition material containing Sb of 89.0 atom % and Ga of 11.0 atom % instead of a phase transition material containing Sb of 87.0 atom % and Ge of 13.0 atom %.

In addition, an optical recording medium comparison sample #1 was manufactured by using a method similar to that of the optical recording medium sample #1, except that the third dielectric film was formed by using a mixed oxide of ZrO₂ and Y₂O₃ of a molar ratio of 97:3 instead of the mixed oxide of ZrO₂ and Cr₂O₃ of a molar ratio of 90:10.

Then, an optical recording medium comparison sample #2 was manufactured by using a method similar to that of the optical recording medium sample #2, except that the first film of the fourth dielectric film and the third dielectric film were formed by using a mixed oxide of ZrO₂ and Y₂O₃ of a molar ratio of 97:3 instead of the mixed oxide of ZrO₂ and Cr₂O₃ of a molar ratio of 90:10.

In addition, an optical recording medium comparison sample #3 was manufactured by using a method similar to that of the optical recording medium sample #2, except that the first film of the fourth dielectric film and the third dielectric film were formed by using a mixed oxide of ZrO₂ and Y₂O₃ of a molar ratio of 97:3 instead of the mixed oxide of ZrO₂ and Cr₂O₃ of a molar ratio of 90:101, and the second dielectric film of the L1 information layer was formed by using a mixed oxide of ZrO₂ and Cr₂O₃ of a molar ratio of 90:10 instead of a mixture of ZrO₂ and Y₂O₃ of a molar ratio of 97:3.

Then, an optical recording medium comparison sample #4 was manufactured by using a method similar to that of the optical recording medium sample #2, except that the first film of the fourth dielectric film was formed by using a mixed oxide of ZrO₂ and Y₂O₃ of a molar ratio of 97:3 instead of the mixed oxide of ZrO₂ and Cr₂O₃ of a molar ratio of 90:10.

In addition, an optical recording medium comparison sample #5 was manufactured by using a method similar to that of the optical recording medium sample #2, except that the third dielectric film was formed by using a mixed oxide of ZrO₂ and Y₂O₃ of a molar ratio of 97:3 instead of the mixed oxide of ZrO₂ and Cr₂O₃ of a molar ratio of 90:10.

Then, an optical recording medium comparison sample #6 was manufactured by using a method similar to that of the optical recording medium sample #2, except that the first film of the fourth dielectric film was formed by using a mixed oxide of ZrO₂ and Y₂O₃ of a molar ratio of 97:3 instead of the mixed oxide of ZrO₂ and Cr₂O₃ of a molar ratio of 90:10, and the second dielectric film of the L1 information layer is formed by using a mixed oxide of ZrO₂ and Cr₂O₃ of a molar ratio of 90:10 instead of the mixed oxide of ZrO₂ and Y₂O₃ of a molar ratio of 97:3.

In addition, an optical recording medium comparison sample #7 was manufactured by using a method similar to that of the optical recording medium sample #2, except that the first film of the fourth dielectric film and the third dielectric film were formed by using a mixed oxide of ZrO₂ and Y₂O₃ of a molar ratio of 97:3 instead of the mixed oxide of ZrO₂ and Cr₂O₃ of a molar ratio of 90:10, and the second film of the fourth dielectric film having a thickness of 12.5 nm is formed by using TiO₂ instead of a mixture of ZnS and SiO₂ of a molar ratio of 80:20.

Then, an optical recording medium comparison sample #8 was manufactured by using a method similar to that of the optical recording medium sample #1, except that the third and fourth dielectric films were formed by using a mixture of ZrO₂ and TiO₂ of a molar ratio of 80:20 instead of the mixed oxide of ZrO₂ and Cr₂O₃ of a molar ratio of 90:10.

In addition, an optical recording medium comparison sample #9 was manufactured by using a method similar to that of the optical recording medium sample #1, except that the third and fourth dielectric films were formed by using a mixture of ZrO₂ and SiO₂ of a molar ratio of 80:20 instead of the mixed oxide of ZrO₂ and Cr₂O₃ of a molar ratio of 90:10.

In addition, an optical recording medium comparison sample #10 was manufactured by using a method similar to that of the optical recording medium sample #1, except that the third and fourth dielectric films were formed by using a mixture of ZrO₂, TiO₂ and SiO₂ of a molar ratio of 40:40:20 instead of the mixed oxide of ZrO₂ and Cr₂O₃ of a molar ratio of 90:10.

The optical recording medium samples #1 and #2 and the optical recording medium comparison samples #1 through #10 that have been manufactured as described above were respectively set on an optical recording medium tester of Pulstec industrial Co, Ltd, Product No.DDU1000, and a laser beam having a channel clock frequency of 132 MHz and a wavelength of 405 nm in a channel bit length of 0.12 μm/bit and modulated based on a predetermined pattern within a power range between the write power Pw and the base power Pb, was irradiated on the L1 recording films of each sample via the light transmission layer by using an object lens having a numerical aperture (NA) of 0.85, while the samples are rotated with a linear velocity of 10.5 m/sec. A recording mark having a length corresponding to a 2T signal through an 8T signal in a 1,7RLL modulation scheme was repeatedly formed over a predetermined number of times between 1 and 1000 to repeatedly overwrite random signals on the L1 information layer over a predetermined number of times between 1 and 1000.

In this case, when the random signals are overwritten to the L1 information layers of each sample, the write power Pw, the erase power Pe, the reproduction power Pr, and the base power Pb of the laser beam were set to 10.6 mW, 4.0 mW, 0.7 mW and 0.3 mW, respectively.

Then, the repetitive overwrite property was tested by setting the reproduction power Pr of the laser beam to 0.7 mW, reproducing the random signals that have been repeatedly overwritten over a predetermined number of times between 1 and 1000, respectively, and measuring a clock jitter % of the reproduction signal.

In this case, the clock jitter was calculated by obtaining a fluctuation a of the reproduction signal using a time interval analyzer based on σ/Tw (Tw: one cycle of a clock).

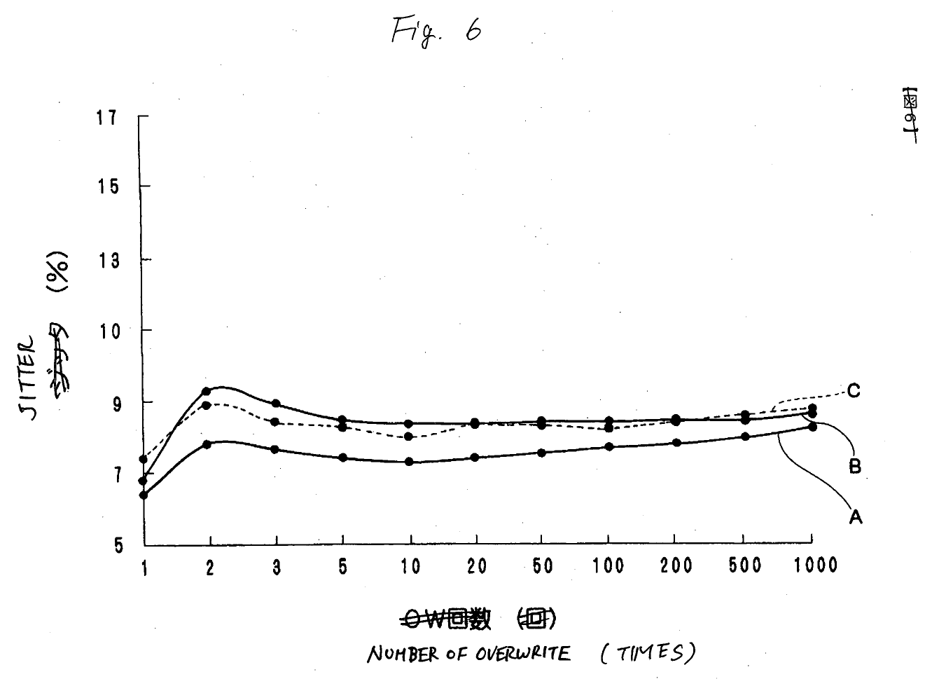

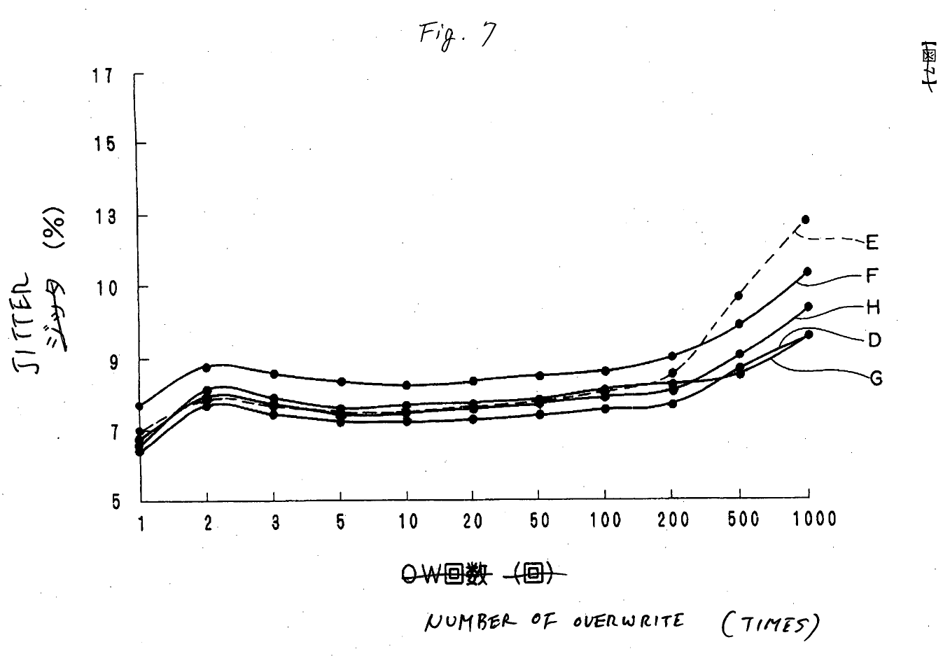

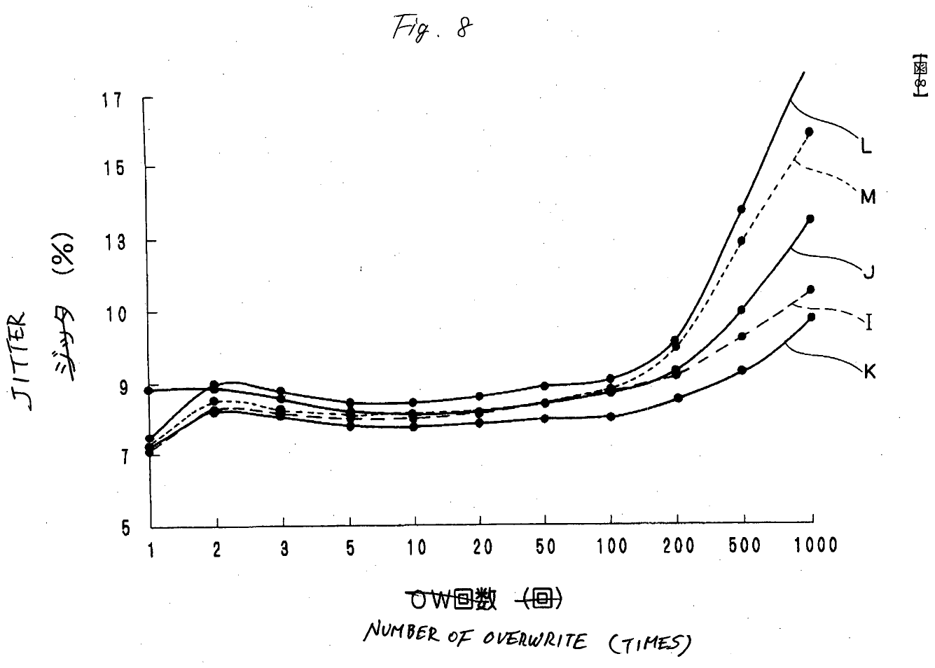

The results of the test of the repetitive overwrite property for the optical recording medium samples #1 through #3 are shown in curves A through C of FIG. 6, respectively. The results of the test of the repetitive overwrite property for the optical recording medium comparison samples #1 through #5 are shown in curves D through H of FIG. 7, respectively. The results of the test of the repetitive overwrite property for the optical recording medium comparison samples #6 through #10 are shown in curves I through M of FIG. 8, respectively.

As shown in FIG. 6, for the optical recording medium samples #1 through #3, when random signals recorded on the L1 information layers of each sample are repeatedly overwritten by new random signals, it is possible to more effectively prevent jitter of the reproduction signals from being degraded as the number of direct-overwrite times is increased. Particularly, it has been proved that it is possible to effectively reduce the jitter when the direct-overwrite is repeated 1000 times in comparison with 10 times. In addition, for the optical recording medium sample #1, it is possible to prevent the jitter in the reproduction signal regardless of the number of times of the direct-overwrite. On the other hand, for the optical medium samples #2 and #3, it has been proved that it is possible to reduce the jitter in the reproduction signal as the number of times of the direct-overwrite is increased.

In comparison, as shown in FIGS. 7 and 8, for all of the optical recording medium comparison samples # 1 through # 10, it has been proved that the jitter of the reproduction signal is degraded as the number of times of the direct-overwrite is increased, and particularly, the jitter is significantly degraded when the direct-overwrite is repeated over 1000 times in comparison with the direct-overwrite is repeated over 10 times, so that degradation of the jitter can not be prevented when the direct-overwrite is repeated.

In addition, similar to recording the random signals on the L1 information layer, a laser beam is irradiated on each of the L0 recording films of the optical recording medium samples #1 through #3 via the light transmission layer and the L1 information layer to write the random signals on the L0 information layer by forming recording marks on each of the L0 recording film. Similar to reproducing the random signals recorded on the L1 information layer, the recorded random signals were reproduced. As a result, it is proved that the random signals can be recorded on the L0 information layer and the random signals recorded on the L0 information layer can be reproduced as desired.

The present invention is not limited to the aforementioned embodiments, but various modification and variation can be made within the scope of the invention disclosed in the claims, which is comprehensive of such modification and variation.

For example, for the optical recording medium 10 shown in FIGS. 1 through 4 and the optical recording medium 100 shown in FIG. 5, although it has been described that both the L1 information layers 30 and 130 are configured, respectively, by stacking the fourth dielectric film 31 and 131, the reflection film 32 and 132, the third dielectric film 33 and 133, the L1 recording film 34 and 134, the second dielectric film 35 and 135, and the first dielectric film 36 and 136, and the heat-sink film 37 and 137, the L1 information layer may include the fourth dielectric film, the reflection film, the third dielectric film, and the L1 recording film from the substrate. But, the aforementioned configuration is not intended to limit other configurations. For example, the L1 information layer may be formed by stacking the fourth dielectric film, the reflection film, the third dielectric film, the L1 recording film, the second dielectric film, and the first dielectric film from the substrate. Otherwise, the L1 information layer may be formed by stacking the fourth dielectric film, the reflection film, the third dielectric film, the L1 recording film, one of the second dielectric film and the first dielectric film, and the heat-sink film from the substrate.

In addition, although it has been described that the optical recording medium 10 shown in FIGS. 1 through 4 and the optical recording medium 100 shown in FIG. 5 have two information layers including the L0 information layer 20 and 120 and the L1 information layer 30 and 130, respectively, the optical recording medium is not required to have two information layers, and the optical recording medium may have three or more information layers interposing the transparent intermediate layer. If the optical recording medium has three or more information layers, all the information layers are not required to include the fourth dielectric film, the reflection film, the third dielectric film, and the L1 recording film from the substrate, but at least one information layer may include the fourth dielectric film, the reflection film, and the third dielectric film, and the L1 recording film from the substrate.

In addition, for the optical recording mediums 10 shown in FIGS. 1 through 4 and the optical recording medium 100 shown in FIG. 5, although it has been described that the L0 information layer farthest from the light incident surface of the laser beam includes the L0 recording film formed of a phase transition material and is configured as a rewritable information layer, the L0 information layer farthest from the light incident surface of the laser beam is not required to be a rewritable information layer, but the L0 information layer may be an only-reproducible information layer or a recordable information layer. For example, if the L0 information layer is configured as an only-reproducible information layer, the L0 recording film may be not provided in the L0 information layer, and the substrate may function as the information layer farthest from the light incident surface of the laser beam. Also, pre-fits are formed on the surface of the substrate, and data is written by such pre-fits.

1. An optical recording medium comprising a plurality of information layers stacked on a substrate through at least a transparent intermediate layer, wherein at least one of the information layers other than the farthest one from a light incident surface of a laser beam includes:
a recording film formed of a phase transition material having an Sb-based eutectic crystal structure;
a reflection film provided at a side of the substrate with respect to the recording film;
at least a first dielectric film interposed between the recording film and the reflection film and adjacent to the reflection film; and
at least a second dielectric film disposed adjacent to the reflection film at a side of the substrate with respect to the reflection film,
and wherein the first dielectric film and the second dielectric film are formed of a material containing a mixed oxide of Zr-based oxide and Cr-based oxide as a major component.

2. The optical recording medium according to claim 1, wherein the second dielectric film is disposed adjacent to the reflection film and comprises a first film formed of a material containing a mixed oxide of Zr-based oxide and Cr-based oxide as a major component and a second film disposed at a side of the second film with respect to the first film.

3. The optical recording medium according to claim 1 or 2, wherein the mixed oxide of Zr-based oxide and Cr-based oxide is a mixed oxide of ZrO₂ and Cr₂O₃.
